(19) United States
(12) Patent Application Publication
(10) Pub. No.: US 2010/0317210 A1
(43) Pub. Date: Dec. 16, 2010

(54) Auxiliary Power Cord Disconnecting Apparatus

(76) Inventors: Daniel James Alberti, Mount Prospect, IL (US); Diane Eileen Alberti, Mount Prospect, IL (US)

Correspondence Address: DANIEL JAMES ALBERTI, 707 W. Lams Court, Mount Prospect, IL, 60056, US

(21) Appl. No.: 12/773,156

(22) Filed: May 4, 2010

Related U.S. Application Data
(60) Provisional application No. 61/268,801, filed on Jun. 16, 2009.

(51) Int. Cl. H01R 13/62

(52) U.S. Cl. 439/152

(57) ABSTRACT

An auxiliary power cord disconnecting apparatus is disclosed. The disconnecting apparatus may include a planar body having apertures spatially aligned to fit prongs on a power cord, a first strip extending from one end of the planar body and having a first fastening mechanism, and a second strip extending from another end of the planar body and having a second fastening mechanism. The first fastening mechanism may mate with the second mechanism to form a loop extending away from the planar body. The loop may provide a user a method to disconnect the power cord from an electrical outlet without placing strain on the power cord itself.

### FIELD OF THE DISCLOSURE

The present disclosure generally relates to a disconnecting apparatus and, in particular, relates to an auxiliary power cord disconnecting apparatus for easy removal of a power cord from a power outlet.

### BACKGROUND OF THE DISCLOSURE

Power cords are commonly coupled with electrically powered devices. Power cords provide an electrical communication path for electricity to travel from a power source to the device. Typically, a power cord, in particular a male power cord, includes a housing member which supports prongs extending from one end and wires/cable/cord extending from the other end. The prongs are coupled to the wires in such a way to make electrical contact.

To create the electrical communication path, the prongs of the male power cord are frictionally coupled with an outlet, receptacle, socket, or other connector capable of frictionally receiving the prongs of the male power cord. Although the frictional coupling of the male power cord with a receiving connector creates a secure electrical connection, it is often difficult to decouple the connection. In order to decouple the electrical connection, the housing member of the power cord must be firmly gripped and pulled away from the receiving connector. Often, the housing member is not within easy reach or convenience. The fear of electrical shock from accidentally touching the prongs while still charged with electricity also keeps people from unplugging the power cord at the housing member.

Thus, people revert to improperly decoupling the power cord from the receiving connector. One method is to pull on the electrical cord instead of the housing member. The strenuous pulling creates unnecessary wear-and-tear on the power cord, resulting in the connection between the wires and prongs to weaken. The weakened connection between the wires and prongs increases the likelihood that a discontinuity or a broken strand of wire may make contact with another wire, causing a short circuit within the housing. If enough wear-and-tear occurs, the electrical cord can become completely detached from the housing member.

Another method is to jerk the power cord from side-to-side until it becomes detached from the receiving connector. The side-to-side motion places strain on the prongs. The wear-and-tear on the prongs may result in them bending or even may result in the prongs breaking off in the receiving connector. A method for safely and durably removing a power cord from an outlet, receptacle, socket, or other receiving connector still remains.

### SUMMARY OF THE DISCLOSURE

In accordance with one aspect of the disclosure, an auxiliary power cord disconnecting apparatus is disclosed. The disconnecting apparatus may include a planar body having apertures spatially aligned to fit prongs on a power cord, a first strip extending from one end of the planar body and having a first fastening mechanism, and a second strip extending from another end of the planar body and having a second fastening mechanism. The first fastening mechanism may mate with the second mechanism to form a loop extending away from the planar body.

In accordance with another aspect of the disclosure, a method for disconnecting a power cord with an auxiliary power cord disconnecting apparatus is disclosed. The method may include coupling the disconnecting apparatus with the power cord by aligning a planar body of the disconnecting apparatus over a front surface of a housing member of the power cord, wherein the planar body includes apertures that snuggly fit over prongs extending from the front surface of the housing member; creating a loop that extends away from the planar body, the loop being formed out of first and second strips extending from the planar body, the first and second strips having first and second fastening mechanisms, respectively, such that the first and second fastening mechanisms mate securely with each other; frictionally coupling the power cord with a receiving connector; and decoupling the power cord from the receiving connector by pulling on the loop.

In accordance with yet another aspect of the disclosure, a power cord with a disconnecting apparatus is disclosed. The power cord may include prongs, an electrical cord having wires, a housing member supporting the prongs and the electrical cord, and a loop operatively coupled to the housing member and capable of distributing a pulling force onto the housing member upon being pulled. The prongs may extend from one end of the housing member, while the electrical cord may extend from the other end of the housing member. The prongs may be electrically coupled to the wires of the electrical cord within the housing member.

Other advantages and features will be apparent from the following detailed description when read in conjunction with the attached drawings.

### BRIEF DESCRIPTION OF THE DRAWINGS

For a more complete understanding of the disclosed apparatus and method, reference should be made to the embodiments illustrated in greater detail in the accompanying drawings, wherein:

FIG. 1 is an embodiment of an auxiliary power cord disconnecting apparatus constructed in accordance with the teachings of the present disclosure;

FIG. 2 shows the auxiliary power cord disconnecting apparatus of FIG. 1 coupled to a power cord prior to being inserted into an outlet; and

FIG. 3 shows the loop of the disconnecting apparatus of FIG. 1 being coupled to a housing member of a power cord.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION OF THE DISCLOSURE

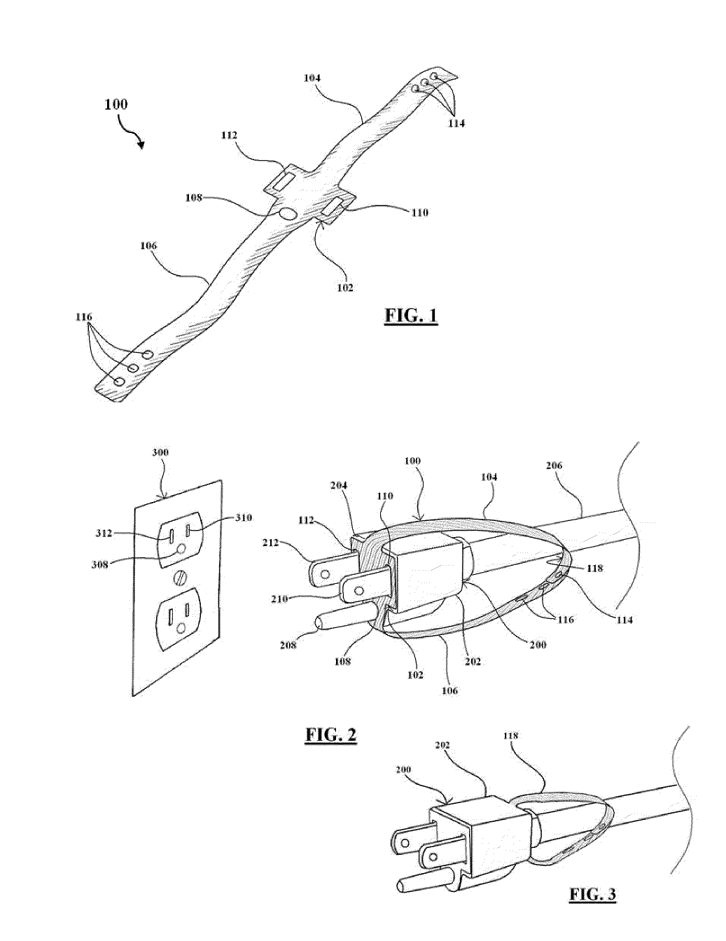

In FIG. 1, an auxiliary power cord disconnecting apparatus 100 which may be practiced in accordance with the present disclosure is illustrated. The disconnecting apparatus 100 may include a planar body 102 having a long elongated strip 104 extending from one end, and another long elongated strip 106 extending from the other end. The planar body 102 may include three apertures 108, 110, 112 spatially distributed to align with prongs on a power cord. The long elongated strip 104 may include a fastening mechanism 114 to mate with a fastening mechanism 116 on the opposing strip 106.

In one exemplary embodiment, the fastening mechanism 114 of the strip 104 may be protrusions, while the fastening mechanism 116 of the other strip 106 may be slotted holes, such that the protrusions 114 may snap into the slotted holes 116. In another exemplary embodiment, the fastening mechanism 114 may be hooks, while the fastening mechanism 116 may be loops, such that the hooks 114 mate with the loops 116 similar to how Velcro works. It should be understood that other fastening mechanisms which may securely fasten strip 104 to strip 106 may be feasible.

In one exemplary embodiment, the disconnecting apparatus 100 may measure 7 inches in length, 1½ inches in width, and 1/16^{th} to ⅛^{th} of an inch in depth. Furthermore, the disconnecting apparatus 100 may be constructed out of flexible, durable, and economical material, such as, but not limited to, plastic.

Referring to FIG. 2, the disconnecting apparatus 100 coupled to a power cord 200 prior to being frictionally coupled to an electrical outlet 300 is illustrated. It should be understood that the disconnecting apparatus 100 may be used to disconnect other types of frictional couplings and should not be limited to only disconnecting power cords 200 from electrical outlets 300.

In operation, the planar body 102 may be coupled to a front surface of a housing member 202 of the power cord 200 in such a manner that the three apertures 108, 110, 112 fit over the three prongs 208, 210, 212, respectively. In one exemplary embodiment, the three apertures 108, 110, 112 fit snuggly over the three prongs 208, 210, 212 to ensure a secure fit. The strips 104, 106 may then be looped towards each other and may be fastened via fastening mechanisms 114, 116 to form a secure durable loop 118. In one exemplary embodiment, the strips 104, 106 may be integrated as one piece, forming the loop 118 without the means of a fastening mechanism. The power cord 200 may then be plugged into the electrical outlet 300, with the prongs 208, 210, 212 of the power cord 200 making frictional contact with receiving holes 308, 310, 312 of the outlet 300, respectively.

To unplug the power cord 200 from the electrical outlet 300, a user may simply pull on the loop 118 instead of pulling on an electrical cord 206 of the power cord 200. The loop 118 may help eliminate any wear-and-tear on the electrical cord 206 by enduring the wear-and-tear being exert onto itself. In one exemplary embodiment, the pulling force on the loop 118 may be evenly distributed across the front surface 204 of the housing member 202 via the planar body 102 of the disconnecting apparatus 100. As the user pulls on the loop 118, the force applied on the loop 118 may be distributed to the planar body 102. The planar body 102, being coupled to the front surface 204 of the housing member 202, may then distribute the force across the front surface 204 evenly. The even distribution of the pulling force across the front surface 204 of the housing member 202 may eliminate the housing member 202 from being jerked side-to-side, thus, reducing the chance of the prongs 208, 210, 212 being bent or broken off in the outlet 300.

In another exemplary embodiment, the loop 118 may be integrated onto the housing member 202 of the power cord 200. As a cost initiative, manufacturers of power cords may find it more economical to integrate the disconnecting apparatus 100 with the power cord 200. The loop 118 may be formed as part of the housing member 202 of the power cord 200 as depicted in FIG. 3. The pulling force on the loop 118 may then be distributed through the entire housing member 202 has opposed to just the front surface 204.

While only certain embodiments have been set forth, alternatives and modifications will be apparent from the above description to those skilled in the art. These and other alternatives are considered equivalents and within the spirit and scope of this disclosure and the appended claims.

What is claimed is:

1. An auxiliary power cord disconnecting apparatus, comprising:
a planar body having apertures spatially aligned to fit prongs on a power cord;
a first strip extending from one end of the planar body and having a first fastening mechanism;
a second strip extending from another end of the planar body and having a second fastening mechanism; and
the first fastening mechanism mating with the second mechanism to form a loop extending away from the planar body.

2. The disconnecting apparatus of claim 1, wherein the planar body, first strip, and second strip are made out of a flexible durable plastic.

3. The disconnecting apparatus of claim 1, wherein the apertures are sized and spatially aligned to fit snuggly over the prongs.

4. The disconnecting apparatus of claim 1, wherein the first fastening mechanism are protrusions, and the second fastening mechanism are slotted holes, such that the protrusions snap into the slotted holes.

5. The disconnecting apparatus of claim 1, wherein the first fastening mechanism are hooks, and the second fastening mechanism are loops, such that the hooks fasten into the loops.

6. The disconnecting apparatus of claim 1, wherein the first fastening mechanism is integrate with the second mechanism to form the loop extending away from the planar body.

7. A method for disconnecting a power cord with an auxiliary power cord disconnecting apparatus, comprising:
coupling the disconnecting apparatus with the power cord by aligning a planar body of the disconnecting apparatus over a front surface of a housing member of the power cord, wherein the planar body includes apertures that snuggly fit over prongs extending from the front surface of the housing member;
creating a loop that extends away from the planar body, the loop being formed out of first and second strips extending from the planar body, the first and second strips having first and second fastening mechanisms, respectively, such that the first and second fastening mechanisms mate securely with each other;
frictionally coupling the power cord with a receiving connector; and
decoupling the power cord from the receiving connector by pulling on the loop.

8. The method of claim 7, wherein pulling on the loop exerts a force onto the planar body, the planar body distributes the force evenly across the front surface of the housing member.

9. The method of claim 7, wherein creating a loop that extends away from the planar body is formed by having the first and second fastening mechanisms being secured with a hook and loop fastening mechanism.

10. The method of claim 7, wherein creating a loop that extends away from the planar body is formed by having the first and second fastening mechanisms being secured with a protrusion and slotted hole snapping mechanism.

11. A power cord with a disconnect apparatus, comprising:
prongs;
an electrical cord having wires;
a housing member supporting the prongs and the electrical cord, wherein the prongs extend from one end of the housing member, while the electrical cord extends from the other end of the housing member, the prongs are electrically coupled to the wires of the electrical cord within the housing member; and
a loop operatively coupled to the housing member and capable of distributing a pulling force onto the housing member upon being pulled.
